(19) United States
(12) Patent Application Publication
(10) Pub. No.: US 2004/0214945 A1
(43) Pub. Date: Oct. 28, 2004

(54) Catioinically polymerizable composition and ink

(75) Inventor: Shunsuke Uozumi, Ibaraki-ken (JP)

Correspondence Address: Kendrew H. Colton, Fitch, Even, Tabin & Flannery, Suite 401L, 1801 K Street, N.W., Washington, DC, 20006, US

(73) Assignee: RISO KAGAKU CORPORATION, Tokyo (JP)

(21) Appl. No.: 10/826,336

(22) Filed: Apr. 19, 2004

(30) Foreign Application Priority Data
Apr. 23, 2003 (JP) 2003-118976

(51) Int. Cl. C08K 3/00

(52) U.S. Cl. 524/551

(57) ABSTRACT

A cationically polymerizable composition excellent in curability, long-term storage stability and stability on heating is provided, which contains at least a cationically polymerizable compound, a cationic polymerization initiator and a nitrogen-containing alicyclic compound, and an ink is also provided which comprises the above composition with a colorant. Preferably the cationically polymerizable compound includes at least an alicyclic epoxy compound and an oxetane compound. The alicyclic compound preferably comprises a secondary amine nitrogen atom as a ring constituent atom, and more preferably contains two or more amine nitrogen atoms, particularly secondary amine nitrogen atoms in one ring thereof, such as pyrazolidine, piperazine, homopiperazine and derivatives thereof. Preferably, the alicyclic compound is present in an amount of from 0.001 to 1% by weight of the total amount of the composition or ink.

### BACKGROUND OF THE INVENTION

1. Field of the Invention

The present invention relates to a cationically polymerizable composition and ink suitable for curing by irradiation with activation energy beam such as ultraviolet light beam.

2. Description of the Related Art

Cationically polymerizable compounds have been used in many industrial fields because they are cationically polymerized and cured by irradiation with activation energy beam and have the advantages that they do not undergo polymerization inhibition in the presence of oxygen, unlike radically polymerizable compounds, and have good adhesion to substrates and small volume shrinkage on curing. Further, since photo-initiated cationic polymerization excels in safety and curing speed, its utilization is expected in many fields. In photo-initiated cationic polymerization, polymerization reaction occurs in cationically polymerizable compounds due to acid or cation generated by irradiating a cationic polymerization initiator with ultraviolet light etc., so that the curing of resin is allowed to progress.

Inks made of such cationically polymerizable compounds are suitable for use in ink-jet recording, particularly for printing on non-absorbing materials such as metals and plastics since they have rapid curability and good adhesion.

Cationically polymerizable compounds used in photo-initiated cationic polymerization include, for example, oxetane compounds, alicyclic epoxy compounds, vinyl ethers, cyclic lactones, cyclic carbonates, spiroorthoesters and spiroorthocarbonates. Of the above cationically polymerizable compounds, oxetane compounds and alicyclic epoxy compounds are conveniently used in combination because they complement the disadvantages of both compounds, that is, low curing speed of oxetane compounds and much irradiation energy required by alicyclic epoxy compounds, and thus excel in both reactivity and curability.

However, cationically polymerizable compositions that contain cationically polymerizable compounds and photopolymerization initiators are generally likely to thicken, and thus hard to ensure a long-term storage stability. Specifically, when cationically polymerizable compounds are stored for a long time with photopolymerization initiators added thereto, acid is generated due to external factor such as heat, even in a state of the compounds being shielded from light, and thus causes cationic polymerization, and hence thickening and gelation. Especially, cationically polymerizable compositions that contain both oxetane compounds and alicyclic epoxy compounds are inferior in storage stability and likely to thicken and gelate, though superior in reactivity and curability. Therefore, they are much poorer in storage stability than the compositions that contain either an oxetane compound or an alicyclic epoxy compound together with a photopolymerization initiator.

In inks that contain cationically polymerizable compositions, pigments are more likely to aggregate due to the thickening and-gelation-of cationically polymerizable compounds, and sometimes cause clogging. Particularly when the ink is used for ink-jet recording, since the ink has to be heated so as to decrease its viscosity at the time of ejection, and thus measures must be taken to inhibit thermal polymerization, thereby avoiding any unexpected difficulty resulting from an increase in viscosity. Further, when inks are often stored under environmental conditions at a high temperature in summer, and, in this case, similar polymerization preventing measures need to be considered.

There have been proposed methods for improving storage stability of oxetane compounds and inhibiting the thickening and gelation of the compound caused by external factors such as heat: for example, a method in which p-methoxyphenol, hydroquinone, catechol, phenothiazine or cupferron is used as a thermal polymerization inhibitor, a method in which a basic compound is used as described in JP-A-2000-327672, and a method in which a straight-chain or branched-chain amine is used as described in JP-A-2000-186079.

However, conventional methods are hardly effective in long-term storage of cationically polymerizable compounds, or even though they are effective in long-term storage of the compounds at room temperature, they are not effective in the storage on heating. Further, as to inks that contain cationically polymerizable compositions, straight-chain or branched-chain amine can sometimes affect dispersion stability of pigments in inks, and therefore, compatibility between the pigment material and the dispersant has to be taken into consideration.

Accordingly, the object of this invention is to solve the problems of prior art and provide cationically polymerizable compositions and inks which are excellent in curability, and besides, long-term storage stability and stability on heating.

### BRIEF SUMMARY OF THE INVENTION

In order to solve the problems of prior art as described above, the inventor has made intensive researches on physical properties of various kinds of amines, such as their structure and base dissociation constant (Kb). As a result, the inventor has found that use of a nitrogen-containing alicyclic compound as a polymerization inhibitor makes it possible to inhibit cationic polymerization reaction from occurring in a cationically polymerizable compound on heating, while photo-initiated cationic polymerizability of the compound is not diminished, thereby ensuring long-term storage stability of cationically polymerizable compositions.

Thus, according to one aspect of this invention, a cationically polymerizable composition is provided which comprises at least a cationically polymerizable compound, a cationic-polymerization initiator, and a nitrogen-containing alicyclic compound.

Furthermore, it has been found that the above cationically polymerizable composition is excellent not only in long-term storage stability and properties of inhibiting polymerization reaction on heating, but also in colorant dispersion stability, and therefore, is suitable for use in inks of activation energy beam-curable type.

Thus, according to another aspect of this invention, a cationically polymerizable ink is provided which comprises the above described cationically polymerizable composition and a colorant.

### DETAILED DESCRIPTION OF THE INVENTION

In this invention, a nitrogen-containing alicyclic compound means a nitrogen-containing heterocyclic compound, namely, a compound having a heterocycle that contains one or more nitrogen atom as a constituent element of its ring, excluding aromatic compounds. The heterocycle is preferably a 5- to 12-membered ring and more preferably 5- to 8-membered ring. As disclosed in JP-A-2000-327672 etc., there have been proposed a method in which a cyclic amine is added to oxetane compounds to improve the storage stability of the same. However, according to the inventors' finding, aromatic imine compounds containing a nitrogen atom in their aromatic rings, such as pyrrole and pyridine, do not act as a polymerization inhibitor, unlike the above described nitrogen-containing alicyclic compounds. This would indicate that a compound having a SP³-hybridized nitrogen acts as a polymerization inhibitor more advantageously than a compound having a SP²-hybridized nitrogen such as a nitrogen constituting a pyridine ring, because the former is higher in degree of freedom of the unshared electron pair of the nitrogen and thus larger in base dissociation constant. Similarly, the cyclic amine is thought to be superior to the aliphatic amine in stability on heating because the former is higher in base dissociation constant and pyrolytic temperatures thanks to its cyclic structure.

Examples of the nitrogen-containing alicyclic compound usable in this invention include cyclic amines such as pyrrolidine, piperidine, N-methylpyrrolidine, 3-pyrrolidinol, N-methylpiperidine, 2-methylpiperidine, 3-methylpiperidine and 4-methylpiperidine and derivatives thereof; cyclic diamines such as pyrazolidine, piperazine, homopiperazine, N-methylpiperazine, 2-methylpiperazine and 2,5-dimethylpiperazine and derivatives thereof; cyclic triamines such as 1,4,7-triazacyclononane and 1,5,9-triazacyclodecane and derivatives thereof; cyclic amines having 4 or more amine portions and derivatives thereof; compounds having 2 or more cyclic amine structures per molecule, such as 1,3-di(4-piperidyl)propane; and morpholine and derivative thereof.

Of these nitrogen-containing alicyclic compounds, those in which an amine nitrogen atom of the ring thereof forms a secondary amine are preferable in terms of steric hindrance, compared with those in which an amine nitrogen atom of the ring thereof forms a tertiary amine. Further, it is preferable that atoms, as ring members, next to the amine nitrogen atoms are not substituted, particularly with a substituent having high molecular weight that causes steric hindrance or with a substituent made up of an electron attractive group.

Further, it is preferable in terms of the stability on heating that the above described nitrogen-containing alicyclic compounds contain two or more amine nitrogen atoms as constituent elements of one ring thereof. Compared with cyclic amines such as piperazine, which contains two or more amine nitrogen atoms per molecule, pyrrolidine, piperidine and the derivatives thereof are a little inferior in stability on heating, and besides, somewhat problematic in terms of their odor.

Of the above described nitrogen-containing alicyclic compounds, compounds containing two or more secondary amine nitrogen atoms as constituent elements of one ring thereof are most preferable, and examples of such compounds are pyrazolidine, piperazine, homopiperazine, and derivatives thereof.

In this invention, the amount of the nitrogen-containing alicyclic compound to be added is preferably 0.001 to 1% by weight of the total amount of the cationically polymerizable composition or of the total amount of the cationically polymerizable ink. Less than 0.001% by weight of the nitrogen-containing alicyclic compound does not give the desired effect as a polymerization inhibitor, whereas more than 1% by weight-inhibits photo-initiated cationic polymerization.

Cationically polymerizable compounds include, for example, cationically polymerizable vinyl compounds, cyclic lactones and cyclic ethers. The cationically polymerizable vinyl compounds include, for example, styrene and vinyl ether. The cyclic ethers include, for example, epoxy compounds, oxetane compounds, and besides, spiroorthoesters, bicycloorthoesters, cyclic carbonates and spiroorthocarbonates.

Epoxy compounds mean compounds having an oxirane group, which is a three-membered ring represented by the following formula (1), and include aromatic epoxy compounds and alicyclic epoxy compounds.

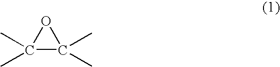

Oxetane compounds mean compounds having an oxetane ring, which is four-membered ring ether represented by the following formula (2).

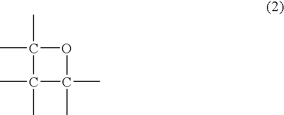

Preferable cationically polymerizable compounds are cyclic ethers that undergo ring-opening polymerization by the action of cations, and more preferably alicyclic epoxy compounds and oxetane compounds. It is particularly preferable to use a mixture of an alicyclic epoxy compound and an oxetane compound, because the mixture provides excellent reactivity and curability. In this case, the mixing ratio of an alicyclic epoxy compound to an oxetane compound, i.e. alicyclic epoxy compound/oxetane compound, is usually 5/95 to 95/5, and preferably 10/90 to 50/50 by weight. When the amount of oxetane is too small, the cured products tend to have poor flexing characteristics and low solvent resistance. On the other hand, when the amount of oxetane is too large, the possibility of inferior curing in a highly humid environment becomes large.

Examples of oxetane compounds include 2-hydroxymethyl-2-methyloxetane, 2-hydroxymethyl-2-ethyloxetane, 2-hydroxymethyl-2-propyloxetane, 2-hydroxymethyl-2-butyloxetane, 1,4-bis{(3-ethyl-3-oxetanylmethoxy)methyl}benzene, 3-ethyl-3-(2-ethylhexyloxymethyl)oxetane and di[1-ethyl(3-oxetanyl)]methyl ether. Commercially available oxetane compounds, such as OXT-212 and OXT-221 (both are trade names) manufactured by Toagosei Co., Ltd., can also be used.

Examples of alicyclic epoxy compounds include alicyclic epoxy resins such as 3,4-epoxycyclohexylmethyl-3′,4′-epoxycyclohexanecarboxylate, bis(3,4-epoxycyclohexylmethyl)adipate, vinylcyclohexenemonoepoxide, ε-caprolactone denaturated 3,4-epoxycyclohexylmethyl-3′,4′-epoxycyclohexanecarboxylate and 1-methyl-4-(2-methyloxiranyl)-7-oxabicyclo(4,1,0]heptane. Commercially available alicyclic epoxy compounds, such as CELLOXIDE 2021, CELLOXIDE 2021A, CELLOXIDE 2021P, CELLOXIDE 2080, CELLOXIDE 2081, CELLOXIDE 3000, CELLOXIDE 2000, EPOLEAD GT301, EPOLEADGT302, EPOLEADGT401, EPOLEADGT403, EHPE-3150 and EHPEL3150CE (all are trade names) produced by Daicel Chemical Industries, Ltd.; CYRACURE UVR-6105, CYRACURE UVR-6110, CYRACURE UVR-6128, CYRACURE UVR-6100, CYRACURE UVR-6216 and CYRACURE UVR-6000 (all are trade names) produced by The Dow Chemical Co., can also be used.

Examples of cationically polymerizable compounds are described in further detail in JP-A-8-143806, JP-A-8-283320, JP-A-2000-186079, JP-A-2000-327672, etc. and this invention can also be implemented using any one properly selected from the compounds illustrated in the above patent documents.

As a cationic polymerization initiator, sulfonium salts, iodonium salts, ammonium salts, phosphonium salts and the like can be used. Examples of such initiators include arylsulfonium salt derivatives (e.g. CYRACURE UVI-6974, CYRACURE UVI-6976, CYRACURE UVI-6990 and CYRACURE UVI-6992 (trade names) produced by The Dow Chemical Co.; ADEKA OPTOMER SP-150, ADEKA OPTOMER SP-152, ADEKA OPTOMER SP-170 and ADEKA OPTOMER SP-172 (trade names) produced by Asahi Denka Co., Ltd.), allyliodonium salt derivatives (e.g. RP-2074 (trade name) produced by Rhodia, Ltd.), allene-ion complex derivatives, diazonium salt derivatives, triazine initiators, and other acid generators such as of halides.

The amount of the cationic polymerization initiator to be added varies depending on the type of the initiator, the type and quantitative ratio of the cationically polymerizable compounds to be used and the conditions under which the initiator is used. For practical purposes, the amount thereof is typically 0.1 to 10% by weight and preferably 1 to 6% by weight based on the total weight of the cationically polymerizable composition or ink. When the amount of the cationic polymerization initiator is too large, storage stability is liable to deteriorate though polymerization progresses rapidly. When the amount of the cationic polymerization initiator is too small, curability becomes inferior.

As a colorant added to the above described cationically polymerizable composition to prepare the cationically polymerizable ink of this invention, pigments and/or dyes can be used. As a pigment, can be used not only organic pigments such as azo-, phthalocyanine-, dye-, condensed polycyclic-, nitro- and nitroso-pigments (including carmine 6B, lake red, disazo yellow, phthalocyanineblue, aniline black, alkali blue, quinacridone, etc.), but also metals such as cobalt, chromium, copper, zinc, lead, titanium, vanadium, manganese and nickel, oxides and sulfides of the metals, and inorganic pigments such as yellow ochre, ultramarine blue, Prussian blue, carbon black, acetylene black, lamp black, titanium oxide and zinc oxide. As a dye, oil-soluble dyes such as azo-, anthraquinone- and azine-dyes can be used. Either a pigment or a dye or both of them may be used; however, if a pigment is used, inks excellent in light-fastness are provided. The colorant content is preferably 0.1 to 50% by weight of the total amount of the cationically polymerizable ink and more preferably 1 to 30% by weight.

Further, the cationically polymerizable composition and ink of this invention can, if necessary, contain other ingredients such as pigment dispersant, anti-oxidant, anti-fungus agent, mildew proofing agent and pH adjustor.

The cationically polymerizable composition of this invention can be produced by sufficiently mixing a cationically polymerizable compound, a cationic polymerization initiator, a nitrogen-containing alicyclic compound and, if necessary, other additives. The cationically polymerizable ink of this invention can be produced by sufficiently mixing a cationically polymerizable compound, a cationic polymerization initiator, a nitrogen-containing alicyclic compound, a colorant and, if necessary, other additives, or by adding a colorant to the cationically polymerizable composition of this invention and mixing them well. Further, a nitrogen-containing alicyclic compound as described above may be added to and sufficiently mixed with an existing cationically polymerizable composition or ink which is made up of a cationically polymerizable compound with a cationic polymerization initiator contained therein, in order to improve storage stability and colorant dispersibility of the composition or the ink. The above mixing can be performed with a disperser such as bead mill, dispersion mixer, homomixer, colloid mill, ball mill, attritor or sand mill.

Viscosity of the cationically polymerizable composition of this invention can be properly adjusted by selecting molecular weight of the cationically polymerizable compounds and combination of the same depending on application of the composition. Particularly when the composition of this invention is used as ultraviolet curable ink for business-use inkjet printers or a vehicle thereof, the viscosity is adjusted to be from 5 to 50 mPa·s and preferably from 10 to 30 mPa·s at 23 degree C.

The cationically polymerizable composition or ink of this invention can be cured by causing polymerization reaction thereof to start in an ordinary manner, for example, by irradiation with an activation energy beam such as ultraviolet light, X-rays and electron rays, or by heating. The cationically polymerizable composition of this invention is suitably used for not only a vehicle of inks, but also polishing varnishes, paints, adhesives, prepregs, sealers, laminates and molding materials.

### EXAMPLES

The present invention will be described in more detail by way of the following examples which should not be construed as limiting the invention thereto.

### Example 1

5.0 parts by weight of a pigment (Carbon Black MA11 (trade name) produced by Mitsubishi Chemical Corporation) and 2.5 parts by weight of a dispersant (Solsperse24000GR (tradename) produced by Avecia KK) were mixed with 25.0 parts by weight of an alicyclic epoxy compound (CELLOXIDE 3000 (trade name) produced by Daicel Chemical Industries, Ltd.) and 75.0 parts by weight of anoxetane compound (OXT-221 (trade name) produced by Toagosei Co., Ltd.) and dispersed with a bead mill.

5.0 parts by weight of a photopolymerization initiator (UVI-6990 (trade name) produced by The Dow Chemical Co.) and 0.1 parts by weight of piperazine as a polymerization inhibitor were added to the resultant dispersion to obtain a cationically polymerizable ink for ink-jet recording.

### Example 2

Ink was obtained in the same manner as in example 1, except that, in place of piperazine, homopiperazine was used as a polymerization inhibitor.

### Example 3

Ink was obtained in the same manner as in example 1, except that, in place of piperazine, 2,5-dimethylpiperazine was used as a polymerization inhibitor.

### Example 4

Ink was obtained in the same manner as in example 1, except that, in place of piperazine, pyrrolidine was used as a polymerization inhibitor.

### Example 5

Ink was obtained in the same manner as in example 1, except that, in place of piperazine, piperidine was used as a polymerization inhibitor.

### Example 6

Ink was obtained in the same manner as in example 1, except that, in place of piperazine, N-methylpiperidine was used as a polymerization inhibitor.

### Comparative Example 1

Ink was obtained in the same manner as in example 1, except that, in place of piperazine, ethylethanolamine was used as a polymerization inhibitor.

### Comparative Example 2

Ink was obtained in the same manner as in example 1, except that, in place of piperazine, pyridine was used as a polymerization inhibitor.

### Comparative Example 3

Ink was obtained in the same manner as in example 1, except that, in place of piperazine, pyrimidine was used as a polymerization inhibitor.

### Comparative Example 4

Ink was obtained in the same manner as in example 1, except that, in place of piperazine, cupferron was used as a polymerization inhibitor.

### Comparative Example 5

Ink was obtained in the same manner as in example 1, except that, in place of piperazine, hydroquinone was used as a polymerization inhibitor.

### Comparative Example 6

Ink was obtained in the same manner as in example 1, except that no polymerization inhibitor was added to the resultant dispersion.

### Comparative Example 7

Ink was obtained in the same manner as in example 1, except that the amount of piperazine added was changed to 2.0 parts by weight.

Evaluation

Inks of Examples 1 to 6 and Comparative Examples 1 to 7 were tested and evaluated in the following manner.

(1) Jettability

Ink jettability was evaluated by ejecting each ink from an ink-jet printer head produced by Xaar. The printer head can eject any kinds of inks as long as they have a viscosity of 10 mPa·s/40° C. or less. The inks of Examples 1 to 6 and Comparative Examples 1 to 7 were all ejected smoothly from the printer head immediately after preparation.

(2) Curing Speed

The inks of Examples 1 to 6 and Comparative Examples 1 to 7 were each ejected from the ink-jet printer head produced by Xaar to form a solid image of about 5 cm×5 cm, and the printed image was exposed to ultraviolet light to be cured. The ultraviolet irradiation was performed with a metal halide lamp produced by EYEGRAPHICS Co., Ltd. at an irradiation intensity of 130 mJ/cm² to cure the image. Inks that were completely cured by only one-time irradiation was marked “◯” and those that were not completely cured even after three-time irradiation was marked “x” as criteria of evaluation. The results are shown in Table 1.

(3) Change in Viscosity

The viscosities of the inks of Examples 1 to 6 and Comparative Examples 1 to 7 were each measured with an E-type viscometer (produced by Toki Sangyo Co., Ltd.) under the conditions of 23° C. and 10 rpm. The viscosities immediately after the inks were prepared (V₀) and those after the inks were left at 70° C. for 4 weeks (V₁) were measured to evaluate the change in viscosity. The ink whose viscosity changing rate (100(V₁-V₀)/V₀) was 10% or less were marked “⊚”, those whose viscosity changing rate was 10 to 30% were marked “◯”, those whose viscosity changing rate was 30 to 50% were marked “Δ”, and those whose viscosity changing rate was more than 50% were marked “x”. The results are shown in Table 1.

(4) Change in Particle Size

The average particle diameters of the pigment in the inks of Examples 1 to 6 and Comparative Examples 1 to 7 were each measured with a dynamic light scattering particle size distribution meter (Horiba, Ltd.). The average particle diameters immediately after the inks were prepared (D₀) and those after the inks were left at 70° C. for 4 weeks (D₁) were measured to evaluate the changes in particle size. Inks whose pigment particle size was hardly changed were marked “◯”, those whose pigment particle size was a little changed, but practically had no problem were marked “Δ”, those whose pigment particle size was so changed that their practical use was problematic were marked “x”, and those whose pigment particle size was too significantly changed to be measured were marked “-”. The results are shown in Table 1.

TABLE 1

| | | | | | | | Com. | Com. | Com. | Com. | Com. | Com. | Com. |
|---|---|---|---|---|---|---|---|---|---|---|---|---|---|
| | Ex. 1 | Ex. 2 | Ex. 3 | Ex. 4 | Ex. 5 | Ex. 6 | ex. 1 | ex. 2 | ex. 3 | ex. 4 | ex. 5 | ex. 6 | ex. 7 |
| CELLOXIDE 3000 | 25.0 | 25.0 | 25.0 | 25.0 | 25.0 | 25.0 | 25.0 | 25.0 | 25.0 | 25.0 | 25.0 | 25.0 | 25.0 |
| OXT-221 | 75.0 | 75.0 | 75.0 | 75.0 | 75.0 | 75.0 | 75.0 | 75.0 | 75.0 | 75.0 | 75.0 | 75.0 | 75.0 |
| UVI-6990 | 5.0 | 5.0 | 5.0 | 5.0 | 5.0 | 5.0 | 5.0 | 5.0 | 5.0 | 5.0 | 5.0 | 5.0 | 5.0 |
| MA11 | 5.0 | 5.0 | 5.0 | 5.0 | 5.0 | 5.0 | 5.0 | 5.0 | 5.0 | 5.0 | 5.0 | 5.0 | 5.0 |
| Sol. 24000GR | 2.5 | 2.5 | 2.5 | 2.5 | 2.5 | 2.5 | 2.5 | 2.5 | 2.5 | 2.5 | 2.5 | 2.5 | 2.5 |
| Piperazine | 0.1 | | | | | | | | | | | | 2.0 |
| Homopiperazine | | 0.1 | | | | | | | | | | | |
| 2,5-dimethylpiperazine | | | 0.1 | | | | | | | | | | |
| Pyrrolidine | | | | 0.1 | | | | | | | | | |
| Piperidine | | | | | 0.1 | | | | | | | | |
| N-methylpiperidine | | | | | | 0.1 | | | | | | | |
| Ethylethanolamine | | | | | | | 0.1 | | | | | | |
| Pyridine | | | | | | | | 0.1 | | | | | |
| Pyrimidine | | | | | | | | | 0.1 | | | | |
| Cupferron | | | | | | | | | | 0.1 | | | |
| Hydroquinone | | | | | | | | | | | 0.1 | | |
| Curing speed | ∘ | ∘ | ∘ | ∘ | ∘ | ∘ | ∘ | ∘ | ∘ | ∘ | ∘ | ∘ | x |
| Initial viscosity V₀ (mPa · s) | 16 | 16 | 16 | 16 | 16 | 16 | 16 | 16 | 16 | 16 | 16 | 16 | 17 |
| Viscosity after left at 70° C. for | 16 | 16 | 17 | 19 | 19 | 20 | 21 | 55 | 60< | 48 | 44 | 60< | 17 |
| 4 weeks V₁ (mPa · s) | | | | | | | | | | | | | |
| Change in viscosity | ⊚ | ⊚ | ⊚ | ∘ | ∘ | ∘ | Δ | x | x | x | x | x | ⊚ |
| Initial particle diameter D₀ (nm) | 68 | 72 | 73 | 70 | 70 | 68 | 68 | 70 | 72 | 72 | 69 | 70 | 69 |
| Particle diameter after left at | 68 | 73 | 73 | 75 | 73 | 75 | 77 | — | — | 129 | 133 | — | 69 |
| 70° C. for 4 weeks D₁ (nm) | | | | | | | | | | | | | |
| Change in particle size | ∘ | ∘ | ∘ | ∘ | ∘ | Δ | Δ | — | — | x | x | — | ∘ |

Note:
“Ex.” refers to Example, and “Com. ex.” refers to Comparative Example.

The symbols in Table 1 mean as follows.

CELLOXIDE 3000: 1-methyl-4-(2-methyloxyranyl)-7-oxabicyclo[4,1,0]heptane, under the trade name of CELLOXIDE 3000 produced by Daicel Chemical Industries, Ltd.

OXT-221: di[1-ethyl (3-oxetanyl)]methylether, under the trade name of OXT-221 produced by Toagosei Co., Ltd.

UVI-6990: a sulfonium salt cationic polymerization initiator, under the trade name of CYRACURE (registered trademark) UVI-6990 produced by The Dow Chemical Co.

MA11: carbon black, under the trade name of Carbon Black MA11 produced by Mitsubishi Chemical Corporation

Sol. 24000GR: a pigment dispersant, under the trade name of Solsperse 24000GR produced by Avecia KK.

Comparison of the Examples and the Comparative Examples reveals that use of nitrogen-containing alicyclic compounds improves storage stability of cationically polymerizable compositions on heating and dispersion stability of colorants. Comparison of Examples 1 to 5 and Example 6 shows that nitrogen-containing alicyclic compounds having a secondary amine are preferable, and comparison of Examples 1 to 3 and Examples 4 to 5 shows that nitrogen-containing alicyclic compounds having two or more amine nitrogen atoms per ring are more preferable.

As described above in detail, according to this invention, a nitrogen-containing alicyclic compound is added to a cationically polymerizable composition or ink that contains a cationically polymerizable compound and a cationic polymerization initiator, and thereby its long-term storage stability and stability on heating are improved while its good curability is maintained without inhibiting photo-initiated cationic polymerization, and besides, dispersion of pigments therein is also maintained satisfactorily.

1. A cationically polymerizable composition, comprising at least a cationically polymerizable compound, a cationic-polymerization initiator, and a nitrogen-containing alicyclic compound.

2. A cationically polymerizable composition according to claim 1, wherein said cationically polymerizable compound comprises at least an alicyclic epoxy compound and an oxetane compound.

3. A cationically polymerizable composition according to claim 1, wherein said nitrogen-containing alicyclic compound comprises a secondary amine nitrogen atom as a constituent element of its ring.

4. A cationically polymerizable composition according to claim 1, wherein said nitrogen-containing alicyclic compound comprises two or more amine nitrogen atoms as constituent elements of one ring thereof.

5. A cationically polymerizable composition according to claim 1, wherein said nitrogen-containing alicyclic compound comprises two or more secondary amine nitrogen atoms as constituent elements of one ring thereof.

6. A cationically polymerizable composition according to claim 1, wherein said nitrogen-containing alicyclic compound is selected from the group consisting of pyrazolidine, piperazine, homopiperazine and derivatives thereof.

7. A cationically polymerizable composition according to claim 1, wherein said nitrogen-containing alicyclic compound is present in an amount of from 0.001 to 1% by weight of the total amount of said composition.

8. A cationically polymerizable composition according to claim 1, wherein said composition is of activation energy beam-curable type.

9. A cationically polymerizable ink, comprising the cationically polymerizable composition according to any one of claims 1 to 6 and a colorant.

10. A cationically polymerizable ink according to claim 9, wherein said nitrogen-containing alicyclic compound is present in an amount of from 0.001 to 1% by weight of the total amount of said ink.

11. A cationically polymerizable ink according to claim 9, wherein said ink is of activation energy beam-curable type.

12. A cationically polymerizable ink according to claim 9, wherein said ink is in a form for use in ink-jet recording.
